(19) United States
(12) Patent Application Publication
(10) Pub. No.: US 2023/0169612 A1
(43) Pub. Date: Jun. 1, 2023

(54) SYSTEMS AND METHODS FOR SMART DRIVE-THROUGH AND CURBSIDE DELIVERY MANAGEMENT

(71) Applicant: Accenture Global Solutions Limited, Dublin (IE)

(72) Inventors: Hector Liguori, Buenos Aires (AR); Alberto Alexis Sattler, Rosario (AR); Anoop Kumar Gopinatha, Issaquah, WA (US); Grady Ha, Van Nuys, CA (US)

(21) Appl. No.: 17/540,204

(22) Filed: Dec. 1, 2021

(51) Int. Cl. G06Q 50/12; G06N 20/00; G06Q 10/08

(52) U.S. Cl. CPC G06Q 50/12; G06N 20/00; G06Q 10/087

(57) ABSTRACT

Aspects of the present disclosure provide systems, methods, and computer-readable storage media that support smart drive through and curbside delivery management. Aspects leverage cameras, computer vision, and machine learning/artificial intelligence to efficiently assign customers to various waiting locations (e.g., drive through lanes, parking spots, etc.) based on factors such as types of orders, customer priority, fulfillment rates at the waiting locations, and queue lengths at the waiting locations. Cameras positioned proximate to customer interface device(s) and waiting locations provide image data that is used to perform computer vision operations to generate vehicle identification information, such as a license plate number or vehicle color. The vehicle identification information and order information is provided to client devices at the assigned waiting location to enable employees to prepare and deliver the order to the customer vehicle. Image data may also be processed to track whether a customer travels to an assigned location.

### TECHNICAL FIELD

The present disclosure relates generally to systems that manage order delivery and pickup with improved customer experience. Particular aspects leverage machine learning and artificial intelligence to support smart drive through order pickup or order delivery, such as to vehicles in parking spaces.

### BACKGROUND

Improvements to technology have resulted in improvements to a variety of activities in peoples' daily lives. One such activity that has been modernized by improvements in technology is the drive through order pickup at restaurants and other businesses. For example, advances in electronic payment technology has allowed a customer that picks up a food order from a drive through window to pay with a credit card, a payment application on a mobile device, and even cryptocurrency, instead of only providing cash in exchange for the food order. As another example, some restaurants have expanded their drive through lane presences to include multiple drive through lanes, some of which include a single kiosk or ordering device that allows an employee to tell a customer which of multiple drive through lanes the customer is to enter with their vehicle. As still another example, the advent of online ordering and payment technology has enabled customers to order and pay before arriving at the restaurant, such that the customer can walk up to a counter or use a drive through lane to quickly retrieve their order without waiting in line to select items for purchase and to provide payment for the purchased items. Some customers prefer to order online using delivery services and have a delivery person retrieve the food order from the store and deliver it to the customer at a location of their choosing.

These advancements have also resulted in problems for restaurants and stores that offer drive through and curbside delivery services. One such problem is the increase in volume of customers (or delivery agents acting on behalf of customers) that are using these services. The recent global pandemic has significantly increased customers' desire for “contactless” order pickup and delivery as compared to conventional in-person dining or shopping. Although speed and customer experience can be improved by supporting online ordering and drive through or curbside pickup, an organization that provides these services has to establish additional lines, drive through lanes, and/or curbside pickup areas, or else risk losing most of the efficiency and customer experience improvements by forcing the customers to wait in line behind other customers that do not use these quicker options. Even if the organization does provide these options, the exact arrival time of the customer cannot be predicted. For example, an online order may include an estimated ready time for the order, but there is no guarantee that the order will be ready at that time due to unforeseen volume of other customers. Additionally, although the customer is provided with the estimated ready time, the customer may not arrive on-time, resulting in difficulties for the organization in scheduling limited drive through and curbside delivery resources. Delays in receiving online orders may especially frustrate customers since these options are often advertised as being faster and less burdensome, which degrades customer experience and reduces a likelihood of future orders or future use of these services.

### SUMMARY

Aspects of the present disclosure provide systems, methods, apparatus, and computer-readable storage media that support smart drive through and curbside delivery management. Systems and methods disclosed herein leverage cameras, computer vision, and machine learning and artificial intelligence to efficiently assign customers to various order pickup locations (e.g., drive through lanes, parking spots, etc.) based on factors such as type of order, customer priority, estimated wait time, order completion rates of the order pickup locations, and quantities of customers currently at the various order pickup locations. As such, aspects of the present disclosure improve store throughput, particularly with respect to order pickup through drive through lanes or curbside delivery, while improving customer experience. In some implementations, customers are matched to vehicles using computer vision or other techniques that do not access any customer-identifiable information, thereby providing smart drive through and delivery services while preserving customer privacy.

To address drive through and curbside delivery congestion, aspects of the present disclosure leverage machine learning/artificial intelligence and computer vision, in combination with online ordering and on premises customer interaction, to provide an efficient (e.g., optimized) customer flow. To illustrate, a customer may place an order with an organization (e.g., a restaurant, a retail store, etc.) using online ordering via a mobile device application or the Internet, and upon arriving on site, the customer may access a customer interface device (e.g., a kiosk) to check-in. The customer interface device may include a camera or scanner capable of scanning indicia displayed on a mobile device of the customer, such as a QR code, to receive order identification (e.g., an order number or other identifier). Additionally or alternatively, the customer interface device may include user interfaces, such as a touch screen, buttons, a keyboard, a microphone, an image capture device, or the like, that enable the customer to enter information by interacting with the touchscreen or speaking the information. The input received by the customer interface device (e.g., the kiosk) is provided to a server or other computing device for processing and automatic assignment of the customer to a selected waiting location (e.g., a drive through lane or parking spot). The waiting location may be selected based on several factors, such as type of customer, requested delivery time, arrival time, type of order, queue lengths, order fulfillment speeds, or the like, as non-limiting examples. In some implementations, the waiting location may be selected by trained machine learning models that are configured to assign customers to queues to satisfy or improve one or more performance indicators based on the factors described above. After selection of the waiting location, the selected waiting location, and optionally additional information such as an estimated waiting time, are provided to the customer by the customer interface device. In some implementations, some or all of the information provided by the customer interface device may also be provided to a mobile device of the customer from which the order is originally placed.

As the customer interacts with the customer interface device, one or more cameras (e.g., image capture devices) may capture images of the customer vehicle. This image data is processed and computer vision operations are performed to identify and extract a license plate number or other vehicle identifier, vehicle color, vehicle make and model, or the like, to generate vehicle identification data. For example, the computer vision operations may include image detection operations to detect the customer vehicle within the images, object recognition operations to identify a license plate or other identifier of the customer vehicle, optical character recognition operations to recognize one or more characters of the license plate or the other identifier, or a combination thereof. The vehicle data information is associated with order data for the customer and provided to one or more client devices to enable an employee (or automated or semi-automated system) to retrieve the customer's order and provide the order to the customer at the selected waiting location, such as a particular drive through lane or parking spot. In this manner, customers may be matched to orders and vehicles using order numbers and image data without using any customer-identifiable or private information, such as names, addresses, payment information, or the like. In some implementations, the cameras continue to capture images as the customer vehicle arrives at a waiting location, and computer vision operations are performed on these additional images to determine if the customer arrived at the selected waiting location or a different location. If the actual waiting location is different than the selected waiting location (e.g., if the customer enters a different drive through lane or pulls into a different parking spot), the client device is provided with updated location information so that the customer's order is provided to the proper location. In some implementations, the server or other computing device is also configured to track performance data and provide output visualizations of performance during selected time periods, to output alerts when performance metrics fall below a threshold, to maintain inventories and output alerts when inventory quantities are estimated to fall below a threshold, to output suggested actions for accounting for measured performance or estimated performance or issues, or a combination thereof.

In a particular aspect, a method for smart drive through and pickup management includes receiving, by one or more processors, order identification data of a customer from a customer interface device. The method also includes obtaining, by the one or more processors, order information based on the order identification data. The method includes receiving, by the one or more processors, image data from one or more image capture devices. The image data includes images of a customer vehicle that is proximate to the customer interface device during entry of an order identifier at the customer interface device. The method also includes performing, by the one or more processors, computer vision operations on the image data to generate vehicle identification data corresponding to the customer vehicle. The method further includes outputting, by the one or more processors, order fulfillment data that includes the order information and the vehicle identification data.

In another particular aspect, a system for smart drive through and pickup management includes one or more image capture devices, a memory, and one or more processors communicatively coupled to the memory and the one or more image capture devices. The one or more processors are configured to receive order identification data of a customer from a customer interface device. The one or more processors are also configured to obtain order information based on the order identification data. The one or more processors are configured to receive image data from the one or more image capture devices. The image data includes images of a customer vehicle that is proximate to the customer interface device during entry of an order identifier at the customer interface device. The one or more processors are also configured to perform computer vision operations on the image data to generate vehicle identification data corresponding to the customer vehicle. The one or more processors are further configured to output order fulfillment data that includes the order information and the vehicle identification data.

In another particular aspect, a non-transitory computer-readable storage medium stores instructions that, when executed by one or more processors, cause the one or more processors to perform operations for smart drive through and pickup management. The operations include receiving order identification data of a customer from a customer interface device. The operations also include obtaining order information based on the order identification data. The operations include receiving image data from one or more image capture devices. The image data includes images of a customer vehicle that is proximate to the customer interface device during entry of an order identifier at the customer interface device. The operations also include performing computer vision operations on the image data to generate vehicle identification data corresponding to the customer vehicle. The operations further include outputting order fulfillment data that includes the order information and the vehicle identification data.

The foregoing has outlined rather broadly the features and technical advantages of the present disclosure in order that the detailed description that follows may be better understood. Additional features and advantages will be described hereinafter which form the subject of the claims of the disclosure. It should be appreciated by those skilled in the art that the conception and specific aspects disclosed may be readily utilized as a basis for modifying or designing other structures for carrying out the same purposes of the present disclosure. It should also be realized by those skilled in the art that such equivalent constructions do not depart from the scope of the disclosure as set forth in the appended claims. The novel features which are disclosed herein, both as to organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1 is a block diagram of an example of a system that supports smart drive through and pickup management according to one or more aspects;

FIG. 2 is a block diagram of an example of a system architecture that supports smart drive through and delivery management according to one or more aspects;

FIG. 3 shows an example of location for order pickup according to one or more aspects;

FIGS. 4A and 4B illustrate examples of graphical user interfaces (GUIs) for display by a customer interface device according to one or more aspects;

FIG. 5 illustrates an example of a GUI for display by a client device according to one or more aspects; and

FIG. 6 is a flow diagram illustrating an example of a method for smart drive through and pickup management according to one or more aspects.

It should be understood that the drawings are not necessarily to scale and that the disclosed aspects are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular aspects illustrated herein.

### DETAILED DESCRIPTION

Aspects of the present disclosure provide systems, methods, apparatus, and computer-readable storage media that support smart drive through and curbside delivery management. Systems and methods disclosed herein leverage cameras, computer vision, and machine learning and artificial intelligence to efficiently assign customers to various order pickup locations (e.g., drive through lanes, parking spots, etc.) to reduce customer wait times, increase throughput for an organization, and improve customer experience. As such, aspects of the present disclosure enable efficient order pickup for an enterprise, such as a restaurant or a retail store, that implements drive through lanes or curbside delivery. In some implementations, customers are matched to orders and vehicles using order numbers and computer vision, thereby avoiding use of any customer-identifiable information, which preserves customer privacy.

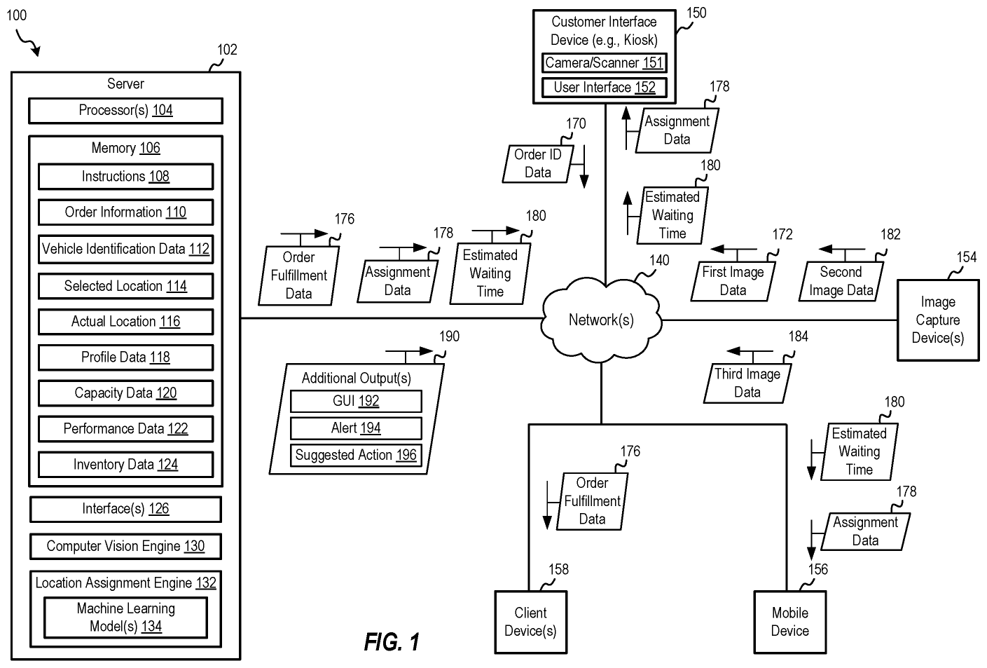

Referring to FIG. 1, an example of a system that supports smart drive through and pickup management according to one or more aspects is shown as a system 100. The system 100 may be configured to manage drive through and/or curbside delivery of orders for an organization or enterprise, including assigning customers to waiting locations and routing orders to customers. As shown in FIG. 1, the system 100 includes a server 102, a customer interface device 150, one or more image capture devices (referred to herein as “image capture devices 154”), a mobile device 156, and one or more client devices (referred to herein as “client devices 158”) and one or more networks 140. In some implementations, one or more of the mobile device 156 and the client devices 158 may be optional, or the system 100 may include additional components.

The server 102 (e.g., a smart drive through and pickup/curbside delivery management device) may, in some other operations, be replaced with or correspond to a desktop computing device, a laptop computing device, a personal computing device, a tablet computing device, a mobile device (e.g., a smart phone, a tablet, a personal digital assistant (PDA), a wearable device, and the like), a virtual reality (VR) device, an augmented reality (AR) device, an extended reality (XR) device, a vehicle (or a component thereof), an entertainment system, other computing devices, or a combination thereof, as non-limiting examples. The server 102 includes one or more processors 104, a memory 106, one or more communication interfaces 126, a computer vision engine 130, and a location assignment engine 132. In some other implementations, one or more of the computer vision engine 130 and the location assignment engine 132 may be optional, one or more additional components may be included in the server 102, or both. It is noted that functionalities described with reference to the server 102 are provided for purposes of illustration, rather than by way of limitation and that the exemplary functionalities described herein may be provided via other types of computing resource deployments. For example, in some implementations, computing resources and functionality described in connection with the server 102 may be provided in a distributed system using multiple servers or other computing devices, or in a cloud-based system using computing resources and functionality provided by a cloud-based environment that is accessible over a network, such as the one of the one or more networks 140. To illustrate, one or more operations described herein with reference to the server 102 may be performed by one or more servers or a cloud-based system that communicates with one or more client or user devices. Alternatively, one or more operations described as being performed by the server 102 may instead be performed by the customer interface device 150, the mobile device 156, and/or the client devices 158.

The one or more processors 104 may include one or more microcontrollers, application specific integrated circuits (ASICs), field programmable gate arrays (FPGAs), central processing units (CPUs) having one or more processing cores, or other circuitry and logic configured to facilitate the operations of the server 102 in accordance with aspects of the present disclosure. The memory 106 may include random access memory (RAM) devices, read only memory (ROM) devices, erasable programmable ROM (EPROM), electrically erasable programmable ROM (EEPROM), one or more hard disk drives (HDDs), one or more solid state drives (SSDs), flash memory devices, network accessible storage (NAS) devices, or other memory devices configured to store data in a persistent or non-persistent state. Software configured to facilitate operations and functionality of the server 102 may be stored in the memory 106 as instructions 108 that, when executed by the one or more processors 104, cause the one or more processors 104 to perform the operations described herein with respect to the server 102, as described in more detail below. Additionally, the memory 106 may be configured to store data and information, such as order information 110, vehicle identification data 112, a selected location 114, an actual location 116, profile data 118, capacity data 120, performance data 122, and inventory data 124. Illustrative aspects of the order information 110, the vehicle identification data 112, the selected location 114, the actual location 116, the profile data 118, the capacity data 120, the performance data 122, and the inventory data 124 are described in more detail below.

The one or more communication interfaces 126 (e.g., one or more network interfaces) may be configured to communicatively couple the server 102 to the one or more networks 140 via wired or wireless communication links established according to one or more communication protocols or standards (e.g., an Ethernet protocol, a transmission control protocol/internet protocol (TCP/IP), an Institute of Electrical and Electronics Engineers (IEEE) 802.11 protocol, an IEEE 802.16 protocol, a 3rd Generation (3G) communication standard, a 4th Generation (4G)/long term evolution (LTE) communication standard, a 5th Generation (5G) communication standard, and the like). In some implementations, the server 102 includes one or more input/output (I/O) devices that include one or more display devices, a keyboard, a stylus, one or more touchscreens, a mouse, a trackpad, a microphone, a camera, one or more speakers, haptic feedback devices, or other types of devices that enable a user to receive information from or provide information to the server 102. In some implementations, the server 102 is coupled to a display device , such as a monitor, a display (e.g., a liquid crystal display (LCD) or the like), a touch screen, a projector, a virtual reality (VR) display, an augmented reality (AR) display, an extended reality (XR) display, or the like. In some other implementations, the display device is included in or integrated in the server 102, or the server 102 is configured to send information for display to an external device, such as the client devices 158, the mobile device 156, and/or the customer interface device 150.

The computer vision engine 130 is configured to receive image data and to perform computer vision operations on the image data to support operations of the server 102. For example, the computer vision engine 130 may be configured to perform pre-processing operations, filtering operations, thresholding operations, masking operations, sampling operations, noise reduction operations, contrast operations, scaling operations, feature extraction, line detection, edge detection, segmentation operations, object detection operations, object recognition operations, optical character recognition operations, text recognition operations, natural language processing operations, other types of computer vision or image processing operations, or a combination thereof. The computer vision operations may be performed to identify particular objects in images, such as vehicles (e.g., cars, trucks, motorcycles, etc.), license plates, identifying characters, occupants of vehicles, as non-limiting examples. The computer vision operations may also be performed to track movement of customer vehicles for use in determining if the customer vehicles moved to assigned waiting locations or different waiting locations.

The location assignment engine 132 may be configured to assign customers to one of a plurality of waiting locations, such as drive through lanes and/or parking spots, based on one or more factors such as customer type, order content, estimated waiting time, arrival time, queue lengths corresponding to the plurality of waiting locations, order fulfillment rates corresponding to the plurality of waiting locations, or the like. As an illustrative example, the location assignment engine 132 may assign a first customer to a first drive through lane with two other customer vehicles in queue and a second customer to a second drive through lane with four other customer vehicles in queue based on the first customer having a higher priority than the second customer, based on an arrival time of the first customer being before an arrival time of the second customer, based on the second drive through lane having a faster order fulfillment rate than the first drive through lane, or based on other factors. The location assignment engine 132 may be configured to assign customers to waiting locations based on one or more rules, based on one or equations or algorithms, to satisfy one or more performance indicators, such as key performance indicators (KPIs), or a combination thereof.

In some implementations, the location assignment engine 132 may be configured to use machine learning to assign customers to waiting locations. For example, the location assignment engine 132 may include or have access to one or more machine learning (ML) models (referred to herein as “ML models 134”) that classify (e.g., assign) customers to waiting locations based on the above-described factors. In some implementations, the ML models 134 may include or correspond to one or more neural networks (NNs), such as convolutional neural networks (CNNs) or recurrent neural networks (RNNs), support vector machines (SVMs), decision trees, random forests, regression models, Bayesian networks (BNs), dynamic Bayesian networks (DBNs), naive Bayes (NB) models, Gaussian processes, hidden Markov models (HMMs), regression models, or the like. The ML models 134 may be trained based on training data that includes labeled historical data that indicates or represents the above-described factors and customer assignment to different waiting locations.

The customer interface device 150 may include or correspond to a kiosk or other interactive electronic device configured to receive user input and to display or otherwise provide output to a customer. The customer interface device 150 may include a computing device, such as a desktop computing device, a server, a laptop computing device, a personal computing device, a tablet computing device, a mobile device (e.g., a smart phone, a tablet, a PDA, a wearable device, and the like), a VR device, an AR device, an XR device, a vehicle (or component(s) thereof), an entertainment system, other computing devices, or a combination thereof, as non-limiting examples. In some implementations, the customer interface device 150 includes a camera/scanner 151 and a user interface 152. The camera/scanner 151 may include a camera (or other image capture device), a scanner, a code reader (e.g., a bar code reader, a QR code reader), or the like, that is configured to receive, scan, or capture identification indicia, such as a QR code, a bar code, an order number, or the like. The user interface 152 may include one or more user interfaces (UIs) or input/output (I/O) devices configured to support customer interfacing. For example, the user interface 152 may include a display device, a touch screen or touch pad, a keyboard, a mouse, a control stick, a trackball, a camera (for facial recognition, gesture recognition, etc.), a microphone, a near field communication (NFC) interface, a radio frequency identifier (RF-ID) interface, a network interface, a wireless communication interface, other types of interfaces or I/O devices, or a combination thereof.

The image capture devices 154 include or correspond to cameras or other image capture devices that are configured to capture images at a location, such as a store, a restaurant, or another location that supports smart drive through lanes and/or curbside delivery/pickup of orders. For example, the image capture devices 154 may include or correspond to cameras, video cameras, digital cameras, security cameras, network cameras, and the like, that are positioned throughout the location. In some implementations, the image capture devices 154 include or correspond to already installed and implemented cameras for other purposes, such as security monitoring. The image capture devices 154 may be edge devices, with respect to the server 102 or other systems of the organization.

The mobile device 156 may be a mobile device of a customer, such as a mobile device that is used to perform online ordering with the organization. The mobile device 156 may include any type of mobile device, such as a smart phone, a tablet, a PDA, a wearable device, a vehicle (or component(s) thereof), or the like, as non-limiting examples. In some implementations, the mobile device 156 may include a display device and a network interface, and the mobile device 156 may be configured to perform online ordering, to communicate with the server 102 or the customer interface device 150, and to display information to a user (e.g., a customer), such as estimated waiting times, assigned waiting locations, and/or order information.

The client devices 158 are configured to communicate with the server 102 via the network 140 to support order deliver. The client devices 158 may include computing devices, such as desktop computing devices, servers, laptop computing devices, personal computing devices, tablet computing devices, mobile devices (e.g., smart phones, tablets, PDAs, wearable devices, and the like), VR devices, AR devices, XR devices, vehicles (or component(s) thereof), entertainment systems, other computing devices, or a combination thereof, as non-limiting examples. The client devices 158 may include processors and memories that store instructions that, when executed by the processors, cause the processors to perform the operations described herein, similar to the server 102. The client device 158 may also include or be coupled to a display device configured to display a graphical user interface (GUI) based on order data, performance data, or inventory data, one or more alerts, one or more suggested actions, or a combination thereof. In some implementations, the client devices 158 include multiple client devices at different locations or associated with different personnel. For example, if the site is configured to support multiple drive through lanes, the client devices 158 may include one or more client devices located within each of the structures that support the drive through lanes (e.g., individual structures or portions of a single structure that provide openings for communication and providing items to customers within customer vehicles). As another example, if the site includes a single structure (e.g., a restaurant or store) that supports curbside delivery, the client devices 158 may include multiple mobile devices assigned to employees that perform curbside deliveries, one or more fixed computing devices within the structure, or a combination thereof).

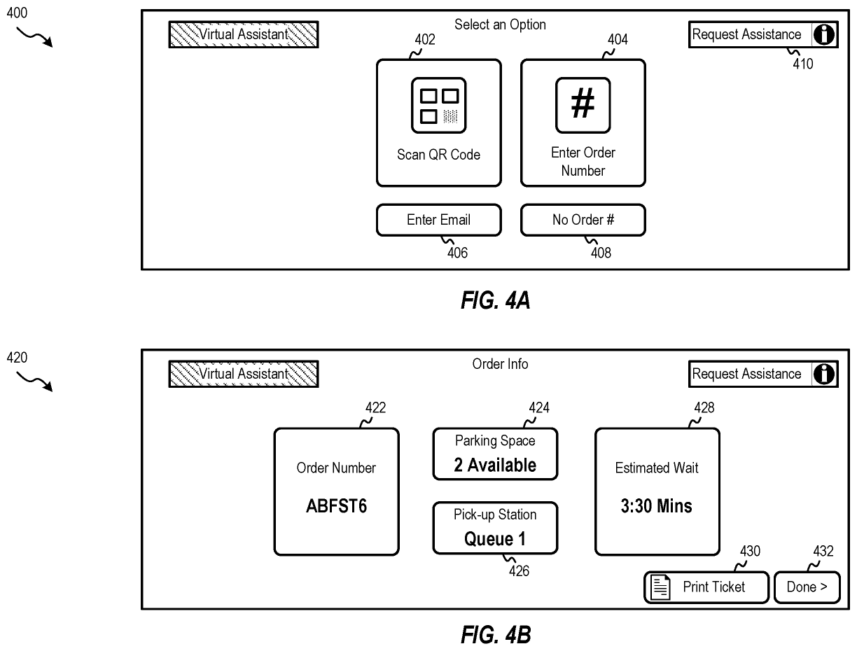

During operation of the system 100, a customer may submit an online order to an organization (e.g., a restaurant, a coffee shop, a retail store, or the like) using an ordering application on the mobile device 156 or the Internet. After placing the online order, the customer (or a delivery person acting on behalf of the customer) may drive to a site at which the organization supports order pickup, particular via drive through lanes and/or curbside delivery. Upon arrival at the site, the customer may interact with the customer interface device 150. For example, the customer interface device 150 may be a kiosk located in a building of the organization, a kiosk in a parking lot or other designated area outside a building, or a drive-up terminal, as non-limiting examples. The customer may interact with the customer interface device 150 to provide an order identifier (ID). For example, the customer interface device 150 may display a GUI that requests entry of an order number, as further described herein with reference to FIG. 4A, and the customer may enter the order ID via the user interface 152 of the customer interface device 150. As non-limiting examples, the user interface 152 may include a touch screen or keypad and the customer may enter the order ID, the mobile device 156 may display order identification indicia (e.g., a QR code or a bar code) and the camera/scanner 151 may scan the order identification indicia, or the user interface 152 may include a microphone and the customer may speak the order ID. Based on user input received from the customer, the customer interface device 150 may generate order ID data 170 that includes the user input representing the order ID. For example, the order ID data 170 may include a scanned code, an order number, a customer number, or a combination thereof. The customer interface device 150 may send (e.g., transmit) the order ID data 170 to the server 102 for processing and extraction of the order ID. For example, if the order ID data 170 includes an image of a QR code, the image may be processed and used to extract the order ID at the server 102. As another example, if the order ID data 170 includes audio data of user speech, the server 102 may perform audio processing, such as sampling, filtering, speech-to-text conversion, and the like, to generate the audio data to text, and then the server 102 may perform one or more natural language processing (NLP) operations on the text to determine the order ID. Although described as being performed at the server 102, in some other implementations, some or all of the processing may be performed at the customer interface device 150.

After receiving the order ID data 170, the server 102 may obtain order information 110 based on the order ID data 170. For example, the server 102 may extract the order ID from the order ID data 170 and use the order ID to access the order information that corresponds to the order ID. In some implementations, the server 102 may be communicatively coupled to an order database via the one or more networks 140, and the order database may store online orders placed via the order application or the Internet. In such implementations, the server 102 may access the order database using the order ID (or a customer ID if one is provided) to retrieve the order information 110 that corresponds to the order ID. In some other implementations, online order data may be stored at the server 102 (e.g., at the memory 106 or another storage location integrated within or coupled to the server 102), and the server 102 may retrieve online order data that corresponds to the order ID as the order information 110. The order information 110 may include information related to the customer, the customer's order, or the like. For example, the order information 110 may include one or more items ordered by the customer, prices associated with the one or more items, an estimated ready time, the order ID, stored customer vehicle identification, payment information, other information associated with the one or items (e.g., storage locations, preparation instructions, etc.), or a combination thereof.

In implementations in which the customer interface device 150 is a drive-up terminal or kiosk, or is otherwise accessible from within a customer vehicle (e.g., a car, a truck, a van, a bus, a motorcycle, a scooter, a recreational vehicle, or the like), the image capture devices 154 may capture images of the customer vehicle to generate first image data 172. For example, the first image data 172 may include images or video frames of the customer vehicle proximate to the customer interface device 150 during entry of the order ID captured by one or more cameras positioned about the site and configured to capture images of a location surrounding the customer interface device 150. The image capture devices 154 may send (e.g., transmit) the first image data 172 to the server 102 for use in identifying the customer vehicle.

The server 102 may receive the first image data 172 and the computer vision engine 130 may perform one or more computer vision operations on the first image data 172 to generate vehicle identification data 112 corresponding to the customer vehicle. For example, if the customer vehicle has an attached license plate, the computer vision engine 130 may perform image detection operations to detect the customer vehicle within the images, object recognition operations to identify a license plate or other identifier of the customer vehicle, optical character recognition operations to recognize one or more characters of the license plate or the other identifier, or a combination thereof, to generate the vehicle identification data 112. As another example, the computer vision engine 130 may perform image detection operations to detect the customer vehicle in the images, object recognition operations to identify the customer vehicle from the rest of the images, and classification operations to determine a make or model of the customer vehicle. As another example, the computer vision engine 130 may perform one or more color detection operations to determine a color of the customer vehicle. Thus, the vehicle identification data 112 may include or indicate at least a partial license plate number or other vehicle identifier, a vehicle color, a make or model, a number of occupants, other identifying information, or a combination thereof. In some implementations, the computer vision engine 130 may perform one or more preprocessing operations, such as filtering operations, sizing or scaling operations, thresholding operations, binarization operations, segmentation operations, or the like, to improve the speed and/or accuracy of the other computer vision operations.

After receiving the order ID data 170 and the first image data 172, the server 102 may select a waiting location (e.g., the selected location 114) to assign to the customer based at least in part on the order information 110. For example, the location assignment engine 132 may select the selected location 114 from a plurality of waiting locations based on the order information 110 and information associated with the site, such as fulfillment times corresponding to the plurality of waiting locations, available waiting locations, number of staff onsite or at the waiting locations, etc. The selected location 114 is a waiting location that is selected from a plurality of waiting locations. For example, the selected location 114 may be a selected drive through lane of a plurality of drive through lanes, a selected parking spot from a plurality of parking spots (e.g., for curbside delivery), or the like. To illustrate waiting location selection, the location assignment engine 132 may assign the customer to a drive through lane that provides a certain type of orders or items based on the order information 110, or to a drive through lane that corresponds to the fastest fulfilment time based on current measurements, or to closer parking spot based on the order information 110 including a large number of items, as non-limiting examples. After selecting the selected location 114, the location assignment engine 132 may generate assignment data 178 that indicates the assignment of the customer vehicle to the selected location 114. The server 102 may provide the assignment data 178 to the customer interface device 150 for display to customer.

In some implementations, the server 102 may obtain the profile data 118 corresponding to the customer. In some such implementations, the server 102 may be communicatively coupled to a customer profile database via the one or more networks 140, and the server 102 may access the customer profile database based on the order ID data 170 (e.g., using the extracted order ID) or a customer ID provided by the customer to retrieve the profile data 118 from the customer profile database. The customer ID may include a name, a profile ID, an account number, or the like. In some other implementations, customer profiles may be stored at the server 102 (e.g., at memory 106 or a storage device that is integrated within or coupled to the server 102). The profile data 118 may indicate a priority associated with the customer, stored vehicle identification information (e.g., license plate number, vehicle color, vehicle make and model, etc.), special instructions associated with the customer, other customer-specific information, or a combination thereof. In some such implementations, the selected location 114 may be selected based further on the profile data 118. For example, a customer having a higher priority (as indicated by the profile data 118) may be assigned to a drive through lane that corresponds to a fast fulfillment rate. The priority may be based on a type of customer (e.g., individual or delivery driver), a frequent customer status, membership in a loyalty program, or any other information relevant for prioritizing customers. As another example, a customer associated with a larger vehicle (as indicated by stored vehicle identification information in the profile data 118) may be assigned to a larger parking spot or a parking spot that is between two empty parking spots.

Although described above as using customer profile information or otherwise associating received information with customers, in some other implementations, the system 100 may be configured to provide order pickup and delivery services without using or storing any personal or identifying information of the customers. For example, the order ID may be a one-time generated ID that is associated with an online order, and the order ID and the order information 110 may not include any customer-identifiable information, such as names, device identifiers, payment information, and the like. Additionally, the vehicle identification data 112 may be generated and associated with the order information 110 using computing vision operations performed on image data and not based on customer-identifiable information. Stated another way, the vehicle identification data 112 may be generated independently of any customer-identifiable information. As another example, the server 102 may receive location data from the mobile device 156, such as global positioning satellite (GPS) data, arrival time-based distance data, or the like, and the server 102 may use the location data to associate one or more images with the customer, to identify the customer vehicle or a location thereof, to track a location of the customer throughout the site, or a combination thereof. Using location data, or other non-identifiable data such as radio-frequency identifier (RF-ID) data, image data, and the like, preserves privacy of the customer during the drive through or delivery process. Thus, in some implementations, the order pickup and delivery services described herein preserve customer privacy and do not leverage any private or personal customer data.

In some implementations, the server 102 may receive waiting location image data from the image capture devices 154. In such implementations, the image capture devices 154 may include one or more cameras positioned to capture images of drive through lanes, parking spots, or any type of waiting locations, to generate second image data 182. The image capture devices 154 may send (e.g., transmit) the second image data 182 to the server 102, and the second image data 182 may be sent periodically, as images are generated, upon request by the server 102, or a combination thereof After the server 102 receives the second image data 182, the computer vision engine 130 may perform computer vision operations on the second image data 182 to determine counts of vehicles located at the plurality of waiting locations (e.g., queue lengths at the plurality of waiting locations). For example, the computer vision operations may include object detection operations and object recognition operations to identify vehicles in a drive through lane or in a parking lot, and the vehicles in each waiting location are counted to generate counts (e.g., queue lengths) for each of the waiting locations. The server 102 may generate the capacity data 120 that indicates the count(s). In some such implementations, the selected location 114 may be further selected based on the capacity data 120. For example, the location assignment engine 132 may assign a customer to a drive through lane that currently includes the fewest vehicles (e.g., that corresponds to the smallest queue length). Another example, the location assignment engine 132 may assign high priority customers to drive through lanes with queue lengths that do not exceed a threshold and that satisfy a threshold fulfillment rate.

In some implementations, selection of the selected location 114 is performed by providing the order information 110 and other information (e.g., waiting location fulfillment rates, customer arrival times, waiting location staffing, etc.), and optionally the profile data 118 and/or the capacity data 120, as input data to the ML models 134. The ML models 134 may be trained to output a selected waiting location of the plurality of waiting locations (e.g., drive through lanes and/or parking spots) for assigning to customers. In some implementations, the server 102 may train the ML models 134 using training data that is generated based on historical order data, historical site information (e.g., waiting location fulfillment rates, staffing information, etc.), historical arrival times, historical profile data, historical capacity data, and the like. In some other implementations, the ML models 134 may be trained by an external device, and the server 102 receives trained ML parameters used to implement the ML models 134. Additionally or alternatively, the server 102 may provide the order information 110, the profile data 118, the capacity data 120, measured performance data, and the selected location 114 as additional training data to continually or periodically train the ML models 134 further based on results within the system 100.

In some implementations, the server 102 may estimate a waiting time at the selected location (e.g., an estimated waiting time 180). The estimated waiting time 180 may be estimated based on queue length at selected location 114, order details (e.g., quantity of items in an order, types of items in an order), measured or estimated fulfillment rates at the selected location 114, staff at the selected location 114, other information, or a combination thereof. The server 102 may send the estimated waiting time 180 to the customer interface device 150 for display to the customer, such as via a GUI displayed by the customer interface device 150. Such a GUI is further described herein with reference to FIG. 4B. In some implementations, in addition to or in the alternative to sending the assignment data 178 and the estimated waiting time 180 to the customer interface device 150, the server 102 may send the assignment data 178, the estimated waiting time 180, the order information 110, or a combination thereof, to the mobile device 156 for display to the customer. The mobile device 156 may be identified to the server 102 during or based on the online ordering process, and providing such information to the mobile device 156 may allow the customer to have access to the selected location 114 (e.g., indicated by the assignment data 178), the order information 110, and the estimated waiting time 180 when the customer vehicle is no longer proximate to the customer interface device 150.

To enable preparation and service of orders to customers, the server 102 may generate order fulfillment data 176 that includes the order information 110 and the vehicle identification data 112. The server 102 may provide the order fulfillment data 176 to the client devices 158. In some implementations, the server 102 may send (e.g., transmit) the order fulfillment data 176 to the particular client device at the selected location 114. In some other implementations, the server 102 may send the order fulfillment data to all (or a designated subset) of the client devices 158. Providing the order fulfillment data 176 to one or more of the client devices 158 enables preparation of and delivery of order to the customer. For example, the server 102 may provide the order fulfillment data 176 to a client device at the drive through lane assigned to customer so that personnel at the drive through lane can prepare the order at the correct drive through lane and that the personnel are able to identify which customer vehicle to provide the order to, based on the vehicle identification data 112. As another example, the server 102 may provide the order fulfillment data 176 to a store (or other single location), particularly to a client device of an available or otherwise selected employee, for preparation of the order and curbside delivery to the customer at a particular parking spot (the selected location 114). In this example, the employee may use the vehicle identification data 112 to verify that a vehicle in the particular parking spot is correct customer vehicle without requiring the employee to keep track of each customer vehicle that arrives by visual inspection of the site.

In some implementations, the server 102 may be configured to track the customer vehicle as it travels to a waiting location to confirm that the customer vehicle arrives at the selected location 114. To illustrate, the server 102 may receive third image data 184 from the image capture devices 154. The third image data 184 includes images displaying the plurality of waiting locations during a time period that the customer vehicle moves away from the customer interface device 150 and travels to a waiting location. The computer vision engine 130 may perform computer vision operations on the third image data 184 to track a location of the customer vehicle and to determine an actual location 116 of the customer vehicle (e.g., a waiting location to which the customer vehicle travels). For example, the computer vision operations may include object recognition operations to identify the customer vehicle and tracking operations to track the customer vehicle to a waiting location (e.g., the actual location 116). If the actual location 116 is different from the selected location 114, the server 102 may update the order fulfillment data 176 to indicate the actual location 116. For example, the order fulfillment data 176 may be updated to include an indication of the actual location 116, such that an employee that receives the order fulfillment data 176 at the selected location 114 will know the customer will not arrive, and the employee may provide the order to the actual location 116 if the actual location 116 is a parking spot, and if the actual location 116 is a different drive through lane, the employee may either transport the order to the other drive through lane or not prepare the order. Additionally or alternatively, updating the order fulfillment data 176 may include providing the order fulfillment data 176 to a different one of the client devices 158 (e.g., a client device at the actual location 116). In this manner, customers that travel to a different waiting location than an assigned waiting location are still served with their order with minimal (or no) employee disruption and increase to fulfillment time.

In some implementations, in addition to assigning customers to waiting locations and routing order fulfillment data the assigned waiting locations, the server 102 may track and maintain various performance and inventory measurements and other data related to order fulfillment. To illustrate, the server 102 may track and maintain the performance data 122 and/or the inventory data 124. The performance data 122 may include one or more performance indicators or key performance indicators (KPIs), such as counts of fulfilled orders, order fulfillment times, order fulfillment rates, counts of fulfillment times that exceed a threshold (e.g., an undesirable fulfillment time), counts of fulfillment rates that satisfy a threshold (e.g., a target rate), other performance metrics, or a combination thereof. The inventory data 124 may indicate available quantities (e.g., one or more supply inventories) of one or more items for use in fulfilling orders, such as particular food items or ingredients, beverages, containers, retail goods, other items, or the like. The server 102 may update the performance data 122 and/or the inventory data 124 as orders are fulfilled. For example, the server 102 may track daily fulfillment rates for the plurality of waiting locations and update the performance data 122 periodically. As another example, the server 102 may update the inventory data 124 to decrease supply inventories for items that are included in the order information 110.

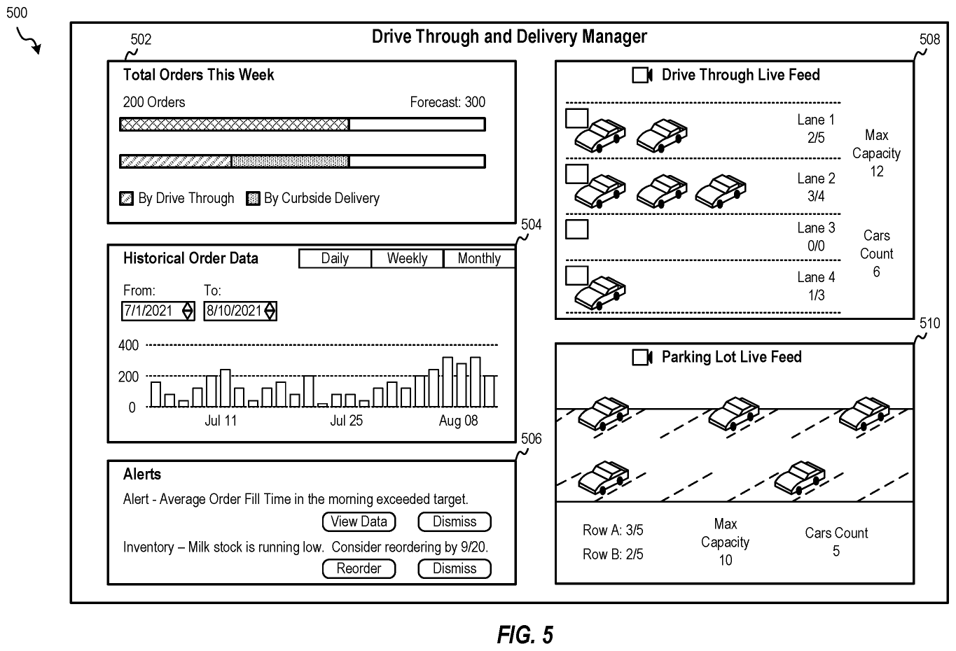

Based on the performance data 122, the inventory data 124, other information, or a combination thereof, the server 102 may output one or more additional outputs 190. The one or more additional outputs 190 may include a GUI 192, an alert 194, a suggested action 196, or a combination thereof. The GUI 192 may be configured to display information based on or including at least a portion of the performance data 122, at least a portion of the inventory data 124, staffing information, historical data, weather data, holidays, other information, or the like. For example, the GUI 192 may be configured to indicate a count of fulfilled orders, order fulfillment times, order fulfillment rates, a count of fulfillment times that exceed a threshold, a count of fulfillment rates that satisfy a threshold, or a combination thereof. An example of such a GUI is further described herein with reference to FIG. 5. The alert 194 may indicate an inventory issue, a staffing issue, a reminder, other important information, or a combination thereof. As non-limiting examples, the alert 194 may be based on a quantity of a supply inventory (e.g., indicated by the inventory data 124) falling below a threshold associated with triggering a resupply, or the alert 194 may indicate that a number of employees scheduled to work at a particular drive through lane fails to satisfy a minimum staff threshold (e.g., due to an employee scheduling a vacation or calling in sick). The suggested action 196 includes a suggested resupply action, a staffing action, a waiting location configuration action, another type of action, or a combination thereof. To illustrate, the server 102 may estimate an order quantity for a future time period (e.g., a day, a week, etc.) and, based on the estimated quantity, the server 102 may output a suggested staffing action to increase a number of employees scheduled for the future time period if the estimated quantity satisfies a threshold. As another example, the server 102 may output a suggested resupplying action based on the estimated quantity if a difference between a current inventory supply and the estimated order quantity satisfies a threshold. As another example, if the estimated order quantity fails to exceed a threshold, the suggested action 196 may include a suggestion to temporarily shut down operation of one or more waiting locations (e.g., drive through lanes) to reduce staff costs while maintaining acceptable order fulfillment rates. The above-described examples are illustrative and are not intended to be limiting, and in other implementations other types of outputs or suggestions may be provided, not limited to sales and fulfillment times by drive through lanes or pickup, current week sales vs. estimated sales, correlation between stock and sales by item/product-type, staffing and occupancy metrics, and the like.

As described above, the system 100 supports smart drive through and curbside delivery to fulfill orders. For example, the server 102 may reduce the amount of time a customer spends in a drive through lane to pick up an order by assigning the customer to a particular drive through lane based on priority, order content, queue length of the drive through lanes, fulfillment rates of the drive through lanes, or the like. The system 100 may also reduce the amount of time a customer spends waiting for curbside delivery based on erroneous or unexpected arrivals by assigning customers to particular parking spots and by leveraging computer vision (e.g., via the computer vision engine 130 and the image capture devices 154) to automatically generate the vehicle identification data 112 that reduces or eliminates deliveries to incorrect customer vehicles. Because the image capture devices 154 may already be placed throughout the site of the organization, such as for security monitoring or other purposes, the system 100 provides a relatively low cost solution as compared to adding expensive new cameras to the site. Additionally or alternatively, the server 102 is able to reduce the amount of time to compensate for customers that travel to an unassigned waiting location by using computer vision operations on images from the image capture devices 154 to automatically track a customer vehicle and to update the order fulfillment data 176 if the customer travels to a different waiting location (e.g., drive through lane) than assigned. By improving the efficiency of order providing and reducing the amount of time a customer waits in a queue (e.g., in a drive through lane or a parking spot), the system 100 provides order delivery and pickup services that improve customer experience and increase a likelihood of customer returns as compared to conventional drive through or curbside delivery services. In some implementations, the system 100 supports the smart drive through and delivery services without accessing (e.g., independently of) any customer-identifiable data, thereby preserving customer privacy and increasing customers willingness to use the services. The system 100 may also provide demand prediction, inventory management, and staff scheduling information in graphs or reports, along with suggested actions, to explain to a user why a suggestion is being made, thereby providing prescriptive solutions that enable the user to make meaningful decisions to improve performance.

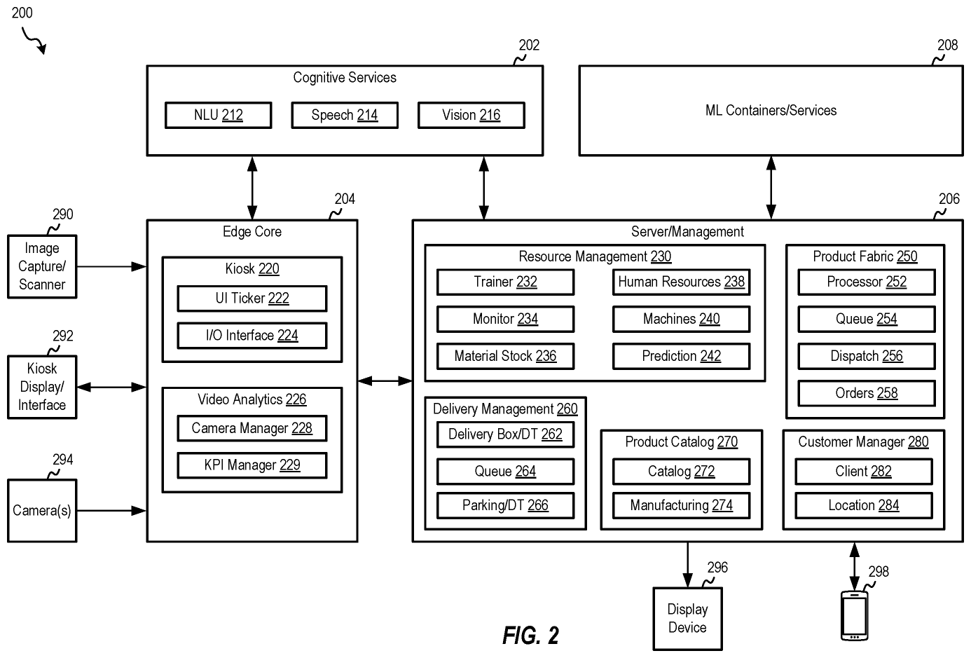

Referring to FIG. 2, a block diagram of an example of a system architecture that supports smart drive through and delivery management according to one or more aspects is shown as a system architecture 200. In some implementations, the system architecture 200 may include or correspond to the system 100 (or components thereof) of FIG. 1. In the example shown in FIG. 2, the system architecture 200 includes cognitive services 202, edge core 204, server/management 206, and ML containers/services 208. Although illustrated as separate components, in some other implementations, one or more of the cognitive services 202, the edge core 204, the server/management 206, and the ML containers/services 208 may be combined or otherwise distributed in the system architecture 200.

The cognitive services 202 include one or more services that process data generated by the edge core 204 to extract relevant information or otherwise convert the data into a form that is supported by the server/management 206. For example, the cognitive services may include a natural language understanding (NLU) service 212, a speech service 214, and a vision service 216 (e.g., a computer vision service). The NLU service 212 may be configured to perform one or more NLP operations and/or one or more NLU operations on received text data to identify and extract characters, words, sentences, or other portions of the text and to interpret meaning. For example, the NLU service 212 may receive text converted from speech and may output a user identifier indicated by the text. The speech service 214 may be configured to perform one or more audio processing operations, one or more speech recognition operations, one or more speech to text conversion operations, or the like, to process incoming audio data. For example, the speech service 214 may convert audio data of customer speech to text data for processing by the NLU service 212. The vision service 216 may be configured to perform one or more computer vision operations on image data to identify, recognize, and/or track objects, such as customer vehicles, in the images. For example, the vision service 216 may be configured to perform any or all of the computer vision operations described with reference to the computer vision engine 130 of FIG. 1.

The edge core 204 may include one or more edge computing device or core computing devices that operate in conjunction with the server/management 206 to support order pickup, customer assignment to waiting locations, customer interaction, and the like. For example, the edge core 204 may include devices or correspond to operations performed by customer interface devices, mobile devices, client devices, other edge devices, or a combination thereof. In the example shown in FIG. 2, the edge core 204 may include a kiosk 220 and video analytics 226. The kiosk 220 may include or correspond to a customer interface device that includes one or more input/output (I/O) devices for enabling customer interaction and a display device or other output device for providing information to the customer. The kiosk 220 may be a drive-up terminal, a free-standing terminal located in a parking lot or outside of an organization's building, an in-store kiosk, or the like. To illustrate, the kiosk 220 may include a user interface (UI) ticker 222 that is configured to output information to be displayed to a customer and an I/O interface 224 configured to enable customer interaction via one or more I/O devices. In some implementations, the I/O interface 224 may receive scanned code data (e.g., of a QR code or other identification indicia) of an order ID from an image capture device/scanner 290 that is coupled to, proximate to, or integrated within the kiosk 220. Additionally or alternatively, the UI ticker 222 may generate and provide output for display (or another type of output, such as audio output, haptic output, etc.) via a kiosk display/interface 292 (e.g., a display screen, a touch screen, a projector, or the like). The video analytics 226 may include a camera manager 228 and a KPI manager 229. The camera manager 228 may be configured to manage and receive images captured by one or more cameras 294 that are positioned through the site (e.g., the parking lot, the drive through lanes, in-store, etc.). The KPI manager 229 may be configured to monitor one or more KPIs based on the images or other information received at the cameras 294.

The server/management 206 may be configured to perform operations to identify customers, assign customers to drive through lanes or parking spots, verify that customer vehicles travel to the assigned waiting locations, enable order delivery, and track and maintain performance metrics and inventories for providing reports, graphs, alerts, and suggested actions. In some implementations, these operations are performed independent of any customer-identifiable data, such as using a non-identifying order number, computer vision operations performed on image data, and/or other non-identifiable information to preserve customer privacy and increase customer willingness to participate in order delivery services provided by the system architecture 200. In the example shown in FIG. 2, the server/management 206 includes resource management 230, product fabric 250, delivery management 260, product catalog 270, and customer manager 280. The resource manager 230 may be configured to manage inventories, staff, machines, and the like, in use by the organization to support order pickup and delivery services. For example, the resource manager 230 may include a trainer 232, a monitor 234, a material stock 236, human resources 238, machines 240, and prediction 242. The trainer 232 may be configured to generate or store training data for use in training ML learning to predict (e.g., estimate) resources at future times. The monitor 234 may be configured to monitor resource use based on resource data, including the material stock 236 (e.g., material or supply inventory data), the human resources 238 (e.g., staff scheduling data, employment data, etc.), and the machines 240 (e.g., machine or equipment inventory and function data). The prediction 242 may be configured to predict (e.g., estimate) resources or resource use for future times, such as future order demand, when various supplies will run out (or fall below thresholds), future understaffed or overstaffed conditions, machine use or replacement times, other information, or a combination thereof. Based on the predictions and the monitored information, the resource management 230 may output reports, graphs, alerts, and/or suggested actions for display to a user via a display device 296 that is coupled to or integrated within the server/management 206 or that is coupled to or integrated within a client device that is communicatively coupled to the server/management 206.

The product fabric 250 may include a processor 252, a queue 254, a dispatch 256, and order 258. The processor 252 may be configured to assign products (e.g., items) to the queue 254 for use in providing orders to customers. The dispatch 256 includes product dispatch information, such as which items are to be included in customer orders included in orders 258. The dispatch 256 may be used to assign tasks to employees in drive through lanes, for curbside delivery, or the like, to facilitate fulfillment of the orders 258. The delivery management 260 may be configured to manage delivery of orders to customers. For example, the delivery management 260 may include a delivery box/drive through (DT) 262, a queue 264, and parking/DT 266. The delivery box/DT 262 may include information that indicates which orders are to be provided to which customers, such as order names, order IDs, vehicle identification information, or a combination thereof. The queue 264 includes identifiers of customers that have checked in (e.g., via the kiosk 220) and assignment of the customers to parking spots or drive through lanes. In some implementations, the delivery management 260 (using the queue 264) may provide an assigned waiting location for display to a customer via the kiosk display/interface 292 or a mobile device 298 of a customer. The parking/DT 266 includes information associated with parking spots or drive through lanes, such as counts of customer vehicles in the parking lot or in one or more of the drive through lanes, maximum capacity of parking areas or drive through lanes, identification of the customer vehicles present in corresponding parking spots or drive through lanes, or the like. If a customer vehicle is identified as traveling to a non-assigned waiting location (e.g., parking spot or drive through lane), the delivery management 260 may update the delivery box/DT 262, the queue 264, and/or the parking/DT 266 to account for the customer vehicle's actual location.

The product catalog 270 may be configured to purchase or initiate manufacture or products or items used to provide customer orders. For example, the product catalog 270 may include a catalog 272 that represents products that can be purchases to restock the material stock 236 and manufacturing 274 that indicates goods or items that can be manufactured by the organization (or others) for restocking the material stock 236. The customer manager 280 may be configured to manage customer information and support online ordering. For example, the customer manager 280 may include a client manager 282 and a location manager 284. The client manager 282 may be configured to store and access customer profiles, online orders, and communication preferences for customers. The location manager 284 may be configured to associate vehicles or people that arrive on-site with the customers managed by the client manager 282.

In some implementations, the server/management 206 may be configured to provide input data to ML containers/services 208 for use by ML models to generate outputs used by the server/management 206 in performing one or more of the above-described operations. The ML containers/services 208 may include one or more ML models, ML containers, ML services, ML training engines, or the like, that are stored in one or more databases (e.g., proprietary ML services) or that include or correspond to one or more third party ML services, such as ML/AI services provided by a cloud services provider (CSP). In some implementations, the ML containers/services 208 may include or correspond to the ML models 134 of FIG. 1.

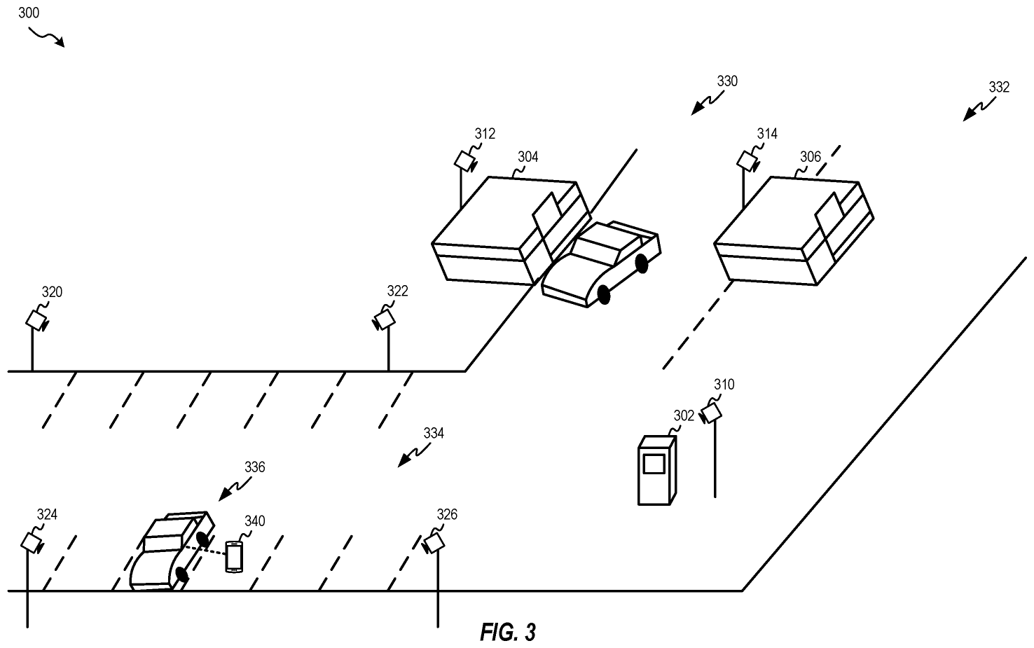

FIG. 3 illustrates an example of a location 300 for order pickup according to one or more examples. The location may include or correspond to a store or restaurant, a combination drive through and parking lot pickup location, or any other type of order pickup location that supports the operations described herein. In some implementations, the location 300 may include components of the system 100 of FIG. 1 and/or the system architecture 200 of FIG. 2.

As shown in the example of FIG. 3, the location 300 may include one or more components of a system for drive through and curbside delivery management, such as a kiosk 302, a first drive through fulfillment structure 304, a second drive through fulfillment structure 306, and one or more image capture devices that include a first camera 310, a second camera 312, a third camera 314, a fourth camera 320, a fifth camera 322, a sixth camera 324, and a seventh camera 326. The kiosk 302 may include or correspond to a drive-up terminal or other type of kiosk that is accessible to a customer inside a vehicle, such as the customer interface device 150 of FIG. 1 or the kiosk 220 of FIG. 2, as non-limiting examples. Drive through fulfillment structures 304 and 306 may be independent structures or portions of a single structure that include client devices to provide order fulfillment data and that store sufficient quantities of products, items, goods, or the like, such that employees (e.g., personnel or staff) that are located within the structures are able to prepare orders and provide the orders to customers in their vehicles outside the structures, such as via a drive through window. The cameras 310-326 may include or correspond to video cameras, digital cameras, security cameras, other types of image capture devices, or combinations thereof, and may be distributed through the location 300. For example, the first camera 310 may be positioned proximate to the kiosk 302, the second camera 312 may be positioned proximate to the first drive through fulfillment structure 304 and/or a first drive through lane 330, the third camera 314 may be positioned proximate to the second drive through fulfillment structure 306 and/or a second drive through lane 332, and cameras 320-326 may be positioned proximate to a parking lot 334. Although one kiosk, two drive through lanes, and seven cameras are illustrated in FIG. 3, in other implementations, more than one kiosk, less than two or more than two drive through lanes, and/or fewer than seven or more than seven cameras may be present at the location 300.

To receive an order, a customer may drive a customer vehicle to the kiosk 302 and use the kiosk 302 to input an order ID, such as by scanning a QR code displayed on a mobile device, entering the order ID via a touchpad or keyboard, speaking the order ID, or any other type of user input described herein. The kiosk 302 may receive the user input and provide the order ID data to a server, such as the server 102 of FIG. 1 or the server/management 206 of FIG. 2, for processing and extraction of the order ID and assignment of the customer to a waiting location (e.g., a drive through lane or a parking spot for curbside delivery). The kiosk may display the assigned waiting location to the customer, and optionally an estimated waiting time, and the customer may drive the customer vehicle from the kiosk 302 to the assigned waiting location. Prior to the customer vehicle leaving an area proximate to the kiosk 302, the first camera 310 may capture one or more images of the customer vehicle that are provided to the server for performance of computer vision operations to identify and extract vehicle identification information, such as a license plate number, a vehicle color, a make and model of the customer vehicle, or the like, as described above with reference to FIG. 1.

If the customer is assigned to a drive through lane, the customer vehicle may travel to one of the drive through lanes 330 or 332. For example, if the customer is assigned to the first drive through lane 330, the customer vehicle may travel to the first drive through lane 330 and wait in a queue, if one exists, until arriving at the first drive through fulfillment structure 304. Based on assignment of the customer to the first drive through lane 330, the server may send order fulfillment data to a client device within the first drive through fulfillment structure 304 to enable preparation of the customer's order for pickup by the customer. The second camera 312 may capture images of the first drive through lane 330 and provide image data to the server for use in performing computer vision operations to confirm that the customer vehicle arrived at the first drive through lane 330. However, if the customer vehicle accidentally travels to the second drive through lane 332 (e.g., a waiting location different than an assigned waiting location), the third camera 314 may capture images of the customer vehicle and provide image data to the server for use in performing computer vision operations to determine that the customer vehicle arrived at the second drive through lane 332. Based on this determination, the server may forward the order fulfillment information to a client device within the second drive through fulfillment structure or perform one or more other operations to facilitate preparation of the customer's order for delivery at the second drive through lane 332.

If the customer is assigned to a parking spot for curbside delivery, the customer vehicle may travel to one of the parking spots within the parking lot 334. For example, if the customer is assigned to a first parking spot 336, the customer vehicle may travel to the first parking spot 336 and wait for curbside delivery of the order. Based on assignment of the customer to the first parking spot 336, the server may send order fulfillment data to a client device associated with an employee that is assigned deliveries to the first parking spot 336, a client device associated with a first available employee, a client device within a store, restaurant, or other order fulfillment structure, or any other client device associated with providing curbside deliveries. One or more of cameras 320-326 may capture images of the customer vehicle at the first parking spot 336 and provide image data to the server for performing computer vision operations to confirm that the customer vehicle has arrived at the assigned waiting location (e.g., the first parking spot 336). Vehicle identification information may be provided to the client device to enable an employee to recognize the customer vehicle without having spent time previously visually inspecting the customer vehicle. In some implementations, the server may provide the assigned waiting location, an estimated wait time, and/or other information to a mobile device 340 of the customer to provide the customer with relevant information and to improve customer experience. However, if the customer vehicle accidentally travels to a different parking sport than the first parking spot 336, one or more of the cameras 320-326 may captures of the customer vehicle at the different parking spot and provide image data to the server for performing computer vision operations to determine that the customer vehicle has arrived at the different parking spot. Based on this determination, the server may forward the order fulfillment information to a client device associated with an employee assigned to provide curbside deliveries to the different parking spot or perform one or more other operations to facilitate preparation of the customer's order for delivery at the different parking spot.

Referring to FIGS. 4A and 4B, examples of GUIs for display by a customer interface device according to one or more aspects are shown. FIG. 4A illustrates a GUI 400 that is displayed at a first time, such as when a customer arrives at the customer interface device. FIG. 4B illustrates a GUI 420 that is displayed at a second time, such as after entry of information via the GUI 400. In some implementations, the GUIs 400 and 420 may be displayed by a kiosk, a drive-up touchscreen device, a drive-up terminal, or the like, such as the customer interface device 150 of FIG. 1, the kiosk 220 of FIG. 2, or the kiosk 302 of FIG. 3.

As shown in FIG. 4A, the GUI 400 includes one or more selectable indicators for inputting an order ID or an order ID, such as buttons, selectable regions, or the like. The selectable indicators may include indicators for a scan option 402, an order number option 404, an email option 406, and a no order number option 408. Selection of any of the options 402-406 by the customer may enable input of an order ID (and/or a customer ID). For example, selection of the scan option 402 may cause a scanner or camera coupled to the customer interface device to capture or scan a QR code displayed by a mobile device of the customer. As another example, selection of the order number option 404 may cause display of a touch keypad for entering an order number, and selection of the email option 406 may cause display of a touch keypad for entering an email address. Selection of the no order number option 408 may cause display of directions or selectable indicators for accessing an order without an order number. Although four specific options are shown in FIG. 4A, in other implementations, one or more of the specific options may not be included, one or more additional options may be provided, and other types of user input (e.g., speech or audio input, etc.) may be supported. Additionally or alternatively, the GUI 400 may include an assistance option 410 which, when selected, provides the customer with assistance services such as frequently asked questions, messaging with an employee, audio or video conferencing with an employee, or the like.

As shown in FIG. 4B, the GUI 420 includes one or more informational items based on an input order number, one or more selectable indicators, or a combination thereof. The informational items may include an order number 422, assigned waiting location information 424 and 426, and an estimated waiting time 428. In the specific example shown in FIG. 4B, the assigned waiting location information 424 and 426 includes available parking spots and a pick-up station assigned to the customer. In some other implementations, assigned waiting location information may include an assigned drive through lane or an assigned parking spot for curbside delivery. Although four specific informational elements are shown in FIG. 4B, in other implementations, one or more of the specific informational elements may not be included, one or more additional informational elements may be provided, or both. The one or more selectable indicators may include indicators for a print ticket option 430, a done option 432, an assistance option, or a combination thereof. Selection of the print ticket option may cause a printer coupled to or integrated within the customer interface device to print a ticket that includes at least a portion of the informational items included in the GUI 420, and selection of the done option 432 may cause the customer interface device to return to displaying the GUI 400.

Referring to FIG. 5, an example of a GUI for display by a client device according to one or more aspects is shown as a GUI 500. In some implementations, the GUI 500 may be displayed by a client device, such as the client devices 158 of FIG. 1 or the display device 296 of FIG. 2. The GUI 500 may be configured to display performance metrics for an organization that supports drive through order pickup and curbside delivery services, historical data, alerts, suggested actions, and one or more on-site camera feeds to enable a user to receive performance information and visually inspect waiting locations for making relevant decisions regarding organization operations. In the example shown in FIG. 5, the GUI 500 an order window 502, a historical order window 504, an alert window 506, a drive through feed 508, and a parking lot feed 510. Although five specific windows are shown in FIG. 5, in some other implementations, the GUI 500 may include fewer than five or more than five windows, and the included windows may provide other types of information, such as suggested actions, inventory status, or the like. Additionally or alternatively, the present application contemplates display of information via graphs or other visual elements, text, images, video or multimedia presentations, audio output, VR or AR content, or any other type of output suitable for conveying the described information.

The order window 502 may include a count of orders for the current week and other related information. In a particular implementation shown in FIG. 5, the order window 502 includes a first graph that indicates the count of orders for the current week with reference to a forecasted order count and a second graph that indicates a break-down of the count of orders for the current week between pickups by drive through and pickups by curbside delivery. The historical order window 504 may include historical order data for a selected time period. In a particular implementation shown in FIG. 5, the historical order window 504 includes selectable indicators for daily, weekly, and month time periods, a beginning date and end date with corresponding buttons, and a graph of the historical order information for the selected time period. The alert window 506 may include one or more alerts generated based on monitored performance data, inventory data, staffing data, date and time, weather data, other information, or the like. As a non-limiting example, the alert window 506 may include a first alert indicating that an average order fill time exceeded a threshold and a second alert indicating that a particular item inventory has fallen below a threshold. In some implementations, the alerts may include selectable indicators to initiate a suggested action to resolve the alert or to dismiss the alert. For example, the first alert may include an option to view the data for the morning order fulfillment to possibly identify a cause of the first alert or an action to perform to account for the first alert, and the second alert may include an option to reorder the corresponding item to restock the inventory.

The drive through feed 508 may include still images or video from one or more image capture devices, such as cameras, positioned on-site to capture images of one or more drive through lanes. For example, the drive through feed 508 may be based on image data from one or more of the second camera 312 or the third camera 314 of FIG. 3, as a non-limiting example. In some implementations, additional information may be overlaid or displayed adjacent to the drive through feed 508. The additional information may include counts of vehicles (e.g., queue lengths) for the drive through lanes, threshold or maximum capacities of each drive through lane, a total count of vehicles in all of the drive through lanes, and a maximum capacity of all of the drive through lanes, as non-limiting examples. The parking lot feed 510 may include still images or video from one or more image capture devices, such as cameras, positioned on-site to capture images of one or more parking spots designated for curbside delivery. For example, the parking lot feed 510 may be based on image data from one or more of the cameras 320-326 of FIG. 3, as a non-limiting example. In some implementations, additional information may be overlaid or displayed adjacent to the parking lot feed 510. The additional information may include counts of vehicles in each row (or other subset) of the parking lot, threshold or maximum capacities of each row, a total count of vehicles in the parking lot, and a maximum capacity of the parking lot, as non-limiting examples.

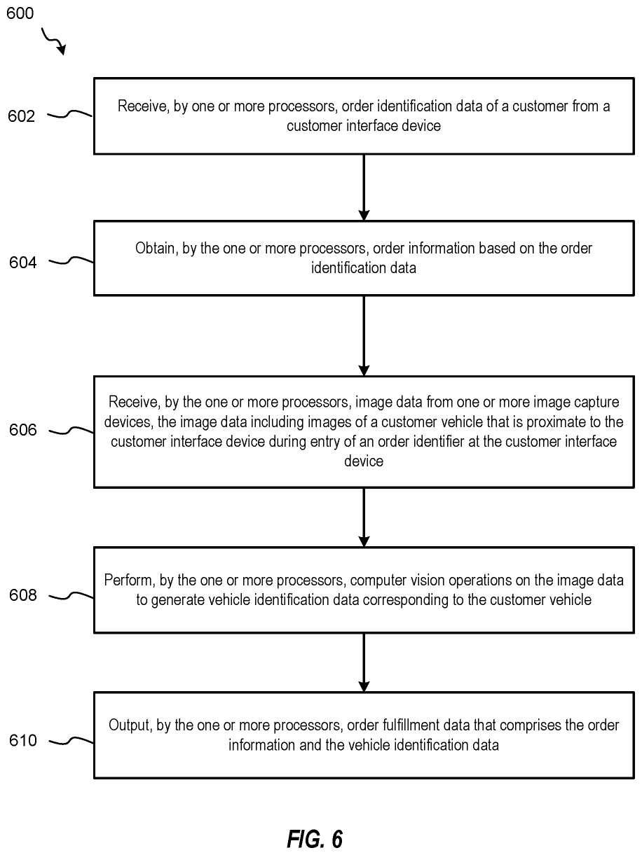

Referring to FIG. 6, a flow diagram of an example of a method for smart drive through and pickup management according to one or more aspects is shown as a method 600. In some implementations, the operations of the method 600 may be stored as instructions that, when executed by one or more processors (e.g., the one or more processors of a computing device or a server), cause the one or more processors to perform the operations of the method 600. In some implementations, the method 600 may be performed by a computing device, such as the server 102 of FIG. 1 (e.g., a computing device configured for smart drive through and pickup management), one or more components of the system architecture 200 of FIG. 2, or a combination thereof.

The method 600 includes receiving order identification data of a customer from a customer interface device, at 602. For example, the order identification data may include or correspond to the order ID data 170 of FIG. 1, and the customer interface device may include or correspond to the customer interface device 150 of FIG. 1. The method 600 includes obtaining order information based on the order identification data, at 604. For example, the order information may include or correspond to the order information 110 of FIG. 1.

The method 600 includes receiving image data from one or more image capture devices, at 606. The image data includes images of a customer vehicle that is proximate to the customer interface device during entry of an order identifier at the customer interface device. For example, the image data may include or correspond to the first image data 172 of FIG. 1.

The method 600 includes performing computer vision operations on the image data to generate vehicle identification data corresponding to the customer vehicle, at 608. For example, the vehicle identification data may include or correspond to the vehicle identification data 112 of FIG. 1. In some implementations, the computer vision operations include image detection operations to detect the customer vehicle within the images, object recognition operations to identify a license plate or other identifier of the customer vehicle, optical character recognition operations to recognize one or more characters of the license plate or the other identifier, or a combination thereof. In some implementations, the vehicle identification data is generated independently of any customer-identifiable information. The method 600 includes outputting order fulfillment data that includes the order information and the vehicle identification data, at 610. For example, the order fulfillment data may include or correspond to the order fulfillment data 176 of FIG. 1.

In some implementations, the method 600 also includes selecting, based at least in part on the order information, a selected waiting location from a plurality of waiting locations and sending assignment data to the customer interface device. The assignment data indicates assignment of the customer vehicle to the selected waiting location. For example, the selecting waiting location may include or correspond to the selected location 114 of FIG. 1, and the assignment data may include or correspond to the assignment data 178 of FIG. 1. As non-limiting examples, the selected waiting location may include a selected drive through lane of a plurality of drive through lanes or a selected parking spot of a plurality of parking spots.

In some such implementations, the method 600 further includes sending an estimated waiting time to the customer interface device. The estimated waiting time corresponds to the selected waiting location. For example, the estimated waiting time may include or correspond to the estimated waiting time 180 of FIG. 1. In some such implementations, the method 600 may also include sending the order information, the estimated waiting time, the assignment data, or a combination thereof, to a mobile device associated with the customer. For example, the mobile device may include or correspond to the mobile device 156 of FIG. 1. Additionally or alternatively, outputting the order fulfillment data may include sending the order fulfillment data to a client device at the selected waiting location to cause one or more ordered items to be provided to the customer vehicle. For example, the client device may include or correspond to the client device 158 of FIG. 1.

In some implementations in which the assignment data is sent to the customer interface device, the method 600 further includes receiving additional image data from the one or more image capture devices, performing object tracking operations on the additional image data to track a location of the customer vehicle and to determine an actual waiting location of the customer vehicle, and based on the actual waiting location being different than the selected waiting location, updating the order fulfillment data to indicate the actual waiting location. For example, the additional image data may include or correspond to the third image data 184 of FIG. 1, and the actual waiting location may include or correspond to the actual location 116 of FIG. 1. Additionally or alternatively, the method 600 may also include accessing a customer profile database based the order identification data to retrieve a customer profile. The selected waiting location is selected based further on the customer profile. For example, the customer profile may store data that includes or corresponds to the profile data 118 of FIG. 1.

In some implementations in which the assignment data is sent to the customer interface device, the method 600 further includes receiving waiting location image data from the one or more image capture devices and performing one or more computer vision operations on the waiting location image data to determine a count of vehicles located at the plurality of waiting locations. The selected waiting location is selected based further on capacity data that indicates the count of vehicles. For example, the waiting location image data may include or correspond to the second image data 182 of FIG. 1 and the capacity data may include or correspond to the capacity data 120 of FIG. 1. In some such implementations, selecting the selected waiting location includes providing the order information and the capacity data as input to one or more ML models to determine the selected waiting location. The one or more ML models are trained to assign customers to the plurality of waiting locations based on types of orders, capacities of the plurality of waiting locations, priorities of the customers or orders, other factors, or a combination thereof. For example, the one or more ML models may include or correspond to the ML models 134 of FIG. 1.

In some implementations, the method 600 also includes maintaining a count of fulfilled orders, order fulfilment times, a count of fulfilment times that exceed a threshold time, or a combo thereof, and outputting a GUI that indicates the count of fulfilled orders, the order fulfilment times, the count of fulfilment times that exceed a threshold time, or a combination thereof. For example, the count of fulfilled orders, the order fulfilment times, the count of fulfilment times that exceed a threshold time, or a combination thereof, may include or correspond to the performance data 122 of FIG. 1, and the GUI may include or correspond to the GUI 192 of FIG. 1. Additionally or alternatively, the method 600 may also include updating one or more supply inventories based on the order information and outputting an alert based on a quantity in the one or more supply inventories falling below a threshold. For example, the one or more supply inventories may include or correspond to the inventory data 124 of FIG. 1, and the alert may include or correspond to the alert 194 of FIG. 1. In some such implementations, the method 600 may further include estimating an order quantity for a future time period and outputting, based on the estimated order quantity, a suggested staffing action, a suggested resupply action, or a combination thereof. For example, the suggested staffing action, the suggested resupply action, or a combination thereof, may include or correspond to the suggested action 196 of FIG. 1.

In some implementations, the vehicle identification data may indicate at least a partial license plate number for the customer vehicle, a vehicle color of the customer vehicle, a vehicle make or model for the customer vehicle, a number of occupants within the customer vehicle, or a combination thereof. Additionally or alternatively, the order identification data may include a scanned code, an order number, a customer number, or a combination thereof. Additionally or alternatively, obtaining the order information may include retrieving the order information from an order database based on the order identification data.

As described above, the method 600 supports smart drive through and curbside delivery to fulfill orders. For example, the method 600 may reduce the amount of time a customer spends in a drive through lane to pick up an order by assigning the customer to a particular drive through lane based on priority, order content, queue length of the drive through lanes, fulfillment rates of the drive through lanes, or the like. Additionally or alternatively, the method 600 may reduce the amount of time a customer spends waiting for curbside delivery based on erroneous or unexpected arrivals by assigning customers to particular parking spots and by leveraging computer vision and image capture devices to automatically generate vehicle identification data that reduces or eliminates deliveries to incorrect customer vehicles. By improving the efficiency of order providing and reducing the amount of time a customer waits in a queue (e.g., in a drive through lane or a parking spot), the method 600 provides order delivery and pickup services that improve customer experience and increase a likelihood of customer returns as compared to conventional drive through or curbside delivery services. In some implementations, the method 600 supports the order pickup and delivery services without accessing or storing any customer-identifiable data, such as names, addresses, device IDs, payment information, etc., thereby preserving customer privacy and increasing customers willingness to use the order pickup and delivery services.

It is noted that other types of devices and functionality may be provided according to aspects of the present disclosure and discussion of specific devices and functionality herein have been provided for purposes of illustration, rather than by way of limitation. It is noted that the operations of the method 600 of FIG. 6 may be performed in any order, or that operations of one method may be performed during performance of another method. It is also noted that the method 600 of FIG. 6 may also include other functionality or operations consistent with the description of the operations of the system 100 of FIG. 1 or the system architecture 200 of FIG. 2.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-6) include processors, electronics devices, hardware devices, electronics components, logical circuits, memories, software codes, firmware codes, among other examples, or any combination thereof. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules, and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. In some implementations, a processor may also be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media can include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, hard disk, solid state disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified—and includes what is specified; e.g., substantially 90 degrees includes 90 degrees and substantially parallel includes parallel—as understood by a person of ordinary skill in the art. In any disclosed aspect, the term “substantially” may be substituted with “within [a percentage] of” what is specified, where the percentage includes 0.1, 1, 5, and 10 percent; and the term “approximately” may be substituted with “within 10 percent of” what is specified. The phrase “and/or” means and or.

Although the aspects of the present disclosure and their advantages have been described in detail, it should be understood that various changes, substitutions and alterations can be made herein without departing from the spirit of the disclosure as defined by the appended claims. Moreover, the scope of the present application is not intended to be limited to the particular implementations of the process, machine, manufacture, composition of matter, means, methods and processes described in the specification. As one of ordinary skill in the art will readily appreciate from the present disclosure, processes, machines, manufacture, compositions of matter, means, methods, or operations, presently existing or later to be developed that perform substantially the same function or achieve substantially the same result as the corresponding aspects described herein may be utilized according to the present disclosure. Accordingly, the appended claims are intended to include within their scope such processes, machines, manufacture, compositions of matter, means, methods, or operations.

What is claimed is:

1. A method for smart drive through and pickup management, the method comprising:
receiving, by one or more processors, order identification data of a customer from a customer interface device;
obtaining, by the one or more processors, order information based on the order identification data;
receiving, by the one or more processors, image data from one or more image capture devices, the image data including images of a customer vehicle that is proximate to the customer interface device during entry of an order identifier at the customer interface device;
performing, by the one or more processors, computer vision operations on the image data to generate vehicle identification data corresponding to the customer vehicle; and
outputting, by the one or more processors, order fulfillment data that comprises the order information and the vehicle identification data.

2. The method of claim 1, wherein the computer vision operations include image detection operations to detect the customer vehicle within the images, object recognition operations to identify a license plate or other identifier of the customer vehicle, optical character recognition operations to recognize one or more characters of the license plate or the other identifier, or a combination thereof.

3. The method of claim 1, wherein the vehicle identification data is generated independently of any customer-identifiable information.

4. The method of claim 1, further comprising:
selecting, by the one or more processors and based at least in part on the order information, a selected waiting location from a plurality of waiting locations; and
sending, by the one or more processors, assignment data to the customer interface device,
wherein the assignment data indicates assignment of the customer vehicle to the selected waiting location.

5. The method of claim 4, wherein the selected waiting location comprises a selected drive through lane of a plurality of drive through lanes.

6. The method of claim 4, wherein the selected waiting location comprises a selected parking spot of a plurality of parking spots.

7. The method of claim 4, further comprising sending, by the one or more processors, an estimated waiting time to the customer interface device,
wherein the estimated waiting time corresponds to the selected waiting location.

8. The method of claim 7, further comprising sending, by the one or more processors, the order information, the estimated waiting time, the assignment data, or a combination thereof, to a mobile device associated with the customer.

9. The method of claim 4, wherein outputting the order fulfillment data comprises sending the order fulfillment data to a client device at the selected waiting location to cause one or more ordered items to be provided to the customer vehicle.

10. The method of claim 4, further comprising:
receiving, by the one or more processors, additional image data from the one or more image capture devices;
performing, by the one or more processors, object tracking operations on the additional image data to track a location of the customer vehicle and to determine an actual waiting location of the customer vehicle; and
based on the actual waiting location being different than the selected waiting location, updating, by the one or more processors, the order fulfillment data to indicate the actual waiting location.

11. The method of claim 4, further comprising accessing a customer profile database based the order identification data to retrieve a customer profile,
wherein the selected waiting location is selected based further on the customer profile.

12. The method of claim 4, further comprising:
receiving, by the one or more processors, waiting location image data from the one or more image capture devices; and
performing, by the one or more processors, one or more computer vision operations on the waiting location image data to determine a count of vehicles located at the plurality of waiting locations,
wherein the selected waiting location is selected based further on capacity data that indicates the count of vehicles.

13. The method of claim 12, wherein:
selecting the selected waiting location comprises providing the order information and the capacity data as input to one or more machine learning (ML) models to determine the selected waiting location;
the one or more ML models are trained to assign customers to the plurality of waiting locations based on types of orders, capacities of the plurality of waiting locations, priorities of the customers or orders, or a combination thereof.

14. A system for smart drive through and pickup management, the system comprising:
one or more image capture devices;
a memory; and
one or more processors communicatively coupled to the memory and the one or more image capture devices, the one or more processors configured to:
receive order identification data of a customer from a customer interface device;
obtain order information based on the order identification data;
receive image data from the one or more image capture devices, the image data including images of a customer vehicle that is proximate to the customer interface device during entry of an order identifier at the customer interface device;
perform computer vision operations on the image data to generate vehicle identification data corresponding to the customer vehicle; and
output order fulfillment data that comprises the order information and the vehicle identification data.

15. The system of claim 14, wherein the vehicle identification data indicates at least a partial license plate number for the customer vehicle, a vehicle color of the customer vehicle, a vehicle make or model for the customer vehicle, a number of occupants within the customer vehicle, or a combination thereof.

16. The system of claim 14, wherein the order identification data includes a scanned code, an order number, a customer number, or a combination thereof.

17. The system of claim 14, further comprising a network interface communicatively coupled to an order database,
wherein the one or more processors are configured to retrieve the order information from the order database based on the order identification data to obtain the order information.

18. A non-transitory computer-readable storage medium storing instructions that, when executed by one or more processors, cause the one or more processors to perform operations for smart drive through and pickup management, the operations comprising:
receiving order identification data of a customer from a customer interface device;
obtaining order information based on the order identification data;
receiving image data from one or more image capture devices, the image data including images of a customer vehicle that is proximate to the customer interface device during entry of an order identifier at the customer interface device;
performing computer vision operations on the image data to generate vehicle identification data corresponding to the customer vehicle; and
outputting order fulfillment data that comprises the order information and the vehicle identification data.

19. The non-transitory computer-readable storage medium of claim 18, wherein the operations further comprise:
maintaining a count of fulfilled orders, order fulfilment times, a count of fulfilment times that exceed a threshold time, or a combo thereof; and
outputting a graphical user interface (GUI) that indicates the count of fulfilled orders, the order fulfilment times, the count of fulfilment times that exceed a threshold time, or a combination thereof.

20. The non-transitory computer-readable storage medium of claim 18, wherein the operations further comprise:
updating one or more supply inventories based on the order information; and
outputting an alert based on a quantity in the one or more supply inventories falling below a threshold.
